(19) United States
(12) Patent Application Publication
(10) Pub. No.: US 2016/0238123 A1
(43) Pub. Date: Aug. 18, 2016

(54) Torsional Vibration Damping Arrangement In A Powertrain Of A Vehicle

(71) Applicant: ZF FRIEDRICHSHAFEN AG, Friedrichshafen (DE)

(72) Inventors: Michael WECHS, Lindau (DE); Thomas MAUZ, Langenargen (DE); Bastian VOLPERT, Friedrichshafen (DE)

(21) Appl. No.: 15/023,998

(22) PCT Filed: Aug. 4, 2014
(86) PCT No.: PCT/EP2014/066689

§ 371 Date: Mar. 22, 2016

(30) Foreign Application Priority Data
Sep. 23, 2013 (DE) 10 2013 219 033.6

(51) Int. Cl. F16H 57/00; F16F 15/12

(52) U.S. Cl. CPC F16H 57/0006; F16F 15/1206; F16H 57/08

(57) ABSTRACT

Torsional vibration damper arrangement in a housing with a drive-side transmission element, an output-side transmission element, and a planetary gear unit arranged there between having a sun gear, an arm supporting a planet gear, and a ring gear with an energy storage and damping element acting at the planetary gear unit. To increase the damping capacity and to accommodate a large energy storage volume and minimize friction effects due to centrifugal accelerations, one of the planetary gear unit members, the sun gear or the arm or the ring gear, can be coupled to the housing via the energy storage and damping element. The energy storage and damping element has a helical compression spring arranged in a circumferential groove in the transmission housing. The groove is spiral-shaped in axial direction of the transmission housing.

PRIORITY CLAIM

This is a U.S. national stage of application No. PCT/EP2014/066689, filed on Aug. 4, 2014. Priority is claimed on German Application No. DE102013219033.6, filed Sep. 23, 2013, the content of which is incorporated here by reference.

### BACKGROUND OF THE INVENTION

1. Field of the Invention

The invention is directed to a torsional vibration damper arrangement mounted in a housing in a powertrain of a vehicle with a drive-side transmission element and an output-side transmission element.

2. Description of the Prior Art

Torsional vibration dampers are arranged in the powertrain of a vehicle, for example between a drive unit and a transmission or within a transmission, in order to suppress the occurrence of excessively strong torque vibrations. The principal feature of a torsional vibration damper of this type is that the energy storage elements, preferably helical compression springs, are arranged between a primary side and a secondary side, i.e., the input side and the output side, of the torsional vibration damper arrangement and form a coupling mechanism. The energy storage elements are located directly in the force flow, and there is no support against a housing. Due to the limited installation space of these known torsional vibration damper arrangements, there is also only a limited energy storage volume that can be realized. Further, the energy storage elements are subject to centrifugal acceleration which is wanted to some extent but, due to friction effects, leads to limitations in the suppression of rotational irregularity.

DE 20 2008 006 078 U1 describes a corresponding torsional vibration damper, particularly for the powertrain of a vehicle, which has a primary side and a secondary side rotatable with respect to the primary side around a rotational axis against the action of a damper element arrangement. One side of the primary side and secondary side has two cover disk elements which are axially spaced apart from one another and the other side of the primary side and secondary side has a central disk element which engages between the cover disk elements. Further, the damper elements of the damper element arrangement are supported with respect to the cover disk elements and central disk element for transmitting torque. In this torsional vibration damper, the damping capacity cannot be increased for reasons relating to installation space because a large energy storage volume cannot be accommodated by helical compression springs. Uncontrolled friction influences due to centrifugal acceleration are minimized in this torsional vibration damper in that the damper element arrangement is accommodated in a spatial region which is filled, or partially filled, with a viscous medium so that the radially outer region of the central disk element and the damper elements move in this viscous medium during relative circumferential movements between the primary side and the secondary side so that a lubricating effect is achieved at the same time that vibrational energy is removed.

A generic torsional vibration damper arrangement is known from DE 44 22 732 A1. This torsional vibration damper has a drive-side transmission element, at least one planet carrier rotatable relative to the latter and provided with at least one planet gear engaging with a sun gear on one side and with a ring gear on the other side, and an output-side transmission element. One of the transmission elements has a control element for a spring device. A flywheel mass is associated in each instance with the drive-side transmission element and with the output-side transmission element, at least one flywheel mass being connected via the spring arrangement to at least one element of the planetary gear unit, which at least one element acts as intermediate mass. The intermediate mass can be driven for a movement that depends on the speed and rotational direction of the two flywheel masses relative to one another. In this known torsional vibration damper, the spring device is also arranged between the drive-side transmission element and the output-side transmission element and rotates with the entire torsional vibration damper unit such that, in this case also, there are only limited options for accommodating a large energy storage volume and eliminating uncontrolled friction effects due to centrifugal acceleration.

### SUMMARY OF THE INVENTION

It is an object of the present invention to suggest a torsional vibration damper arrangement with the highest possible damping capacity and a large energy storage volume. Further, the suggested torsional vibration damper arrangement should minimize friction effects due to centrifugal acceleration and make possible the largest possible twist angle between the drive-side transmission element and the output-side transmission element in order to provide a comparatively large working capacity.

The invention is based, first, on a torsional vibration damper arrangement mounted in a housing in a powertrain of a vehicle with a drive-side transmission element and an output-side transmission element and with a planetary gear unit that arranged between the drive-side transmission element and the output-side transmission element having a sun gear, an arm supporting at least one planet gear and a ring gear and, with at least one energy storage and damping element acting at the planetary gear unit. In this torsional vibration damper arrangement, it is provided according to one embodiment of the invention that one of the planetary gear unit members, namely, the sun gear or the arm or the ring gear, can be coupled to the housing via the at least one energy storage and damping element.

In this regard, the one planetary gear unit member can be coupled to the at least one energy storage and damping element directly and such that it cannot be disengaged during operation, or the one planetary gear unit member can be coupled to the at least one energy storage and damping element indirectly such that it can be disengaged during operation.

Accordingly, the energy storage and damping element is not arranged in the powertrain between a drive-side transmission element and an output-side transmission element, but rather is fastened either permanently or temporarily to the housing of the torsional vibration damper arrangement. Consequently, there are also no spatial limitations such as in an arrangement between a drive-side transmission element and an output-side transmission element, and a large energy storage volume can be realized in or at the housing. Further, there are also no friction effects due to centrifugal acceleration, since the energy storage and damping element does not rotate when carrying out its energy storage function/damping function.

If the one planetary gear unit member is coupled to the at least one energy storage and damping element indirectly and such that it can be disengaged during operation, this can be implemented by a brake between the one planetary gear unit member and the energy storage and damping element or a freewheel between the one planetary gear unit member and the energy storage and damping element.

With the freewheel in its simplest form, the brake can be selectively actuated, while the coupled planetary gear unit member is secured in one rotational direction and freely rotatable in the other rotational direction. Further, there are known switchable freewheels that make it possible to selectively block or release a freewheel or to reverse the blocking direction of the freewheel. Switchable freewheels of this type can also be used in conjunction with the torsional vibration damper arrangement according to the invention.

At least one planetary gear set can be arranged within a gear unit in the powertrain of a vehicle, in which at least one of the planetary gear unit members of at least one planetary gear set can be coupled to the housing via at least one energy storage and damping element. In this way, a simple epicyclic manual transmission can be realized in which the torsional vibration damper arrangement is active whenever at least one of the planetary gear unit members of at least one planetary gear set is coupled to the housing via at least one energy storage and damping element.

When the gear unit has at least two planetary gear sets with connection to the housing, one of the planetary gear unit members of each of the at least two planetary gear sets with a housing link can be coupled to the housing and can be actuated interchangeably. For this purpose, a parallel and/or serial connection to the housing is possible. This is particularly advantageous when the planetary gear sets are arranged in an epicyclic automatic transmission and can then be used jointly without requiring additional planetary gear units with housing link.

Particularly epicyclic automatic transmissions with at least substantially cylindrical transmission housing are suitable for accommodating a large energy storage volume for helical compression springs arranged in a circumferential groove in the housing, which circumferential groove is at least partially open radially toward the inside. A circumferential groove of this type having a cross section that is very much larger than a space that would be provided for a co-rotating torsional vibration damper can be accommodated in the transmission housing. Further, substantially more energy storage volume can be made available for damping torsional vibrations when the circumferential groove extends in a spiral-shaped manner in axial direction of the housing over more than one circumference length.

In this regard, it is preferably provided that the helical compression springs and the associated damping member of the energy storage and damping element are inserted into the circumferential groove of the transmission housing in circumferential direction and are supported by one end at a planetary gear unit member (sun gear, arm or ring gear) and by the other end thereof at a stop in the spiral-shaped circumferential groove.

The above-mentioned vehicle transmission can be an epicyclic automatic transmission, an automatic spur gear transmission or automatic compound transmission with a transfer case, a main gear unit and/or a range gear unit, and the individual sub-gear units are formed as spur gear units or as planetary gear units.

With respect to the planetary gear set present in the torsional vibration damper arrangement, it can be provided that this planetary gear set is formed as minus gear unit with a stationary gear ratio having a value of less than zero or as a plus gear unit with a stationary gear ratio having a value of greater than zero.

The planet gears of the planetary gear unit of the torsional vibration damper arrangement can be formed as step planet gears, as spur gears, or as bevel gears.

A second constructional form of the torsional vibration damper arrangement that meets one object and follows the basic principle of the invention will be described in the following. This torsional vibration damper arrangement can also be connected on the input side to an internal combustion engine and on the output side to a vehicle transmission which provides the ratios for the vehicle drive. The torsional vibration damper arrangement according to the second constructional form likewise has a gear unit, but one which, unlike the planetary gear units described above, has a stationary gear ratio with the value one so that its input speed corresponds to the output speed. This gearing behavior is advantageous particularly when a torsional vibration damper arrangement which is constructed according to the invention and installed in an existing powertrain should not change the ratios provided therein—particularly the ratios provided by the vehicle transmission—on the input side of the vehicle transmission.

The second constructional form of the torsional vibration damper arrangement is also received in a housing and drivingly arranged in a powertrain of a vehicle between an internal combustion engine and the above-mentioned vehicle transmission. As in the first constructional form, the torsional vibration damper arrangement according to the second constructional form has a gear unit with a drive-side transmission element and an output-side transmission element. The drive-side transmission element can be connected to the drive shaft of the internal combustion engine, and the output-side transmission element can be connected to the input shaft of the vehicle transmission. The drive-side transmission element is formed as a first toothed wheel which meshes with a second toothed wheel arranged on a shaft and fixed with respect to rotation relative to it. A third toothed wheel, which is in toothed engagement with the output-side transmission element formed as a fourth toothed wheel, is arranged on the above-mentioned shaft so as to be fixed with respect to rotation relative to it. The second constructional form of the torsional vibration damper arrangement has at least one support which supports the above-mentioned shaft, a ring gear or a sun gear of the gear unit. An energy storage and damping element having at least one damping member and at least one helical compression spring which are arranged parallel to one another in operative direction is fastened to the support. The energy storage and damping element is connected to the housing on the radially outer side or can be connected to this housing via a clutch or brake.

As can be seen, the gear unit arranged in the torsional vibration damper arrangement according to the second constructional form is not a conventional planetary gear unit or conventional planetary gear set because one of the elements comprising sun gear, ring gear, and arm or planet carrier is lacking in this gear unit; instead, one of the existing elements comprising sun gear, ring gear, and arm or planet carrier is duplicated. The advantage of this transmission arrangement consists in that it has a gear ratio of 1 as described above.

In the torsional vibration damper arrangement according to the second constructional form, it can be provided, by itself or in addition to one or more of the above-mentioned features of the first constructional form of the torsional vibration damper arrangement, that the drive-side transmission element and the output-side transmission element of the gear unit are formed as first spur gear and as fourth spur gear, respectively, which mesh with the second spur gear and third spur gear, respectively. Beyond this, it can be provided according to another further development that the third spur gear and the fourth spur gear mesh with an individual ring gear of the gear unit.

According to one embodiment, the drive-side transmission element of the gear unit of the torsional vibration damper arrangement according to the second constructional form is formed as a first ring gear and the output-side transmission element of this gear unit is formed as a second ring gear, which first ring gear and second ring gear mesh with the second spur gear and third spur gear, respectively. Further, it can be additionally provided that the second spur gear and the third spur gear mesh with an individual sun gear of the gear unit of the torsional vibration damper arrangement according to the second constructional form.

According to one embodiment, the third spur gear of the gear unit of the torsional vibration damper arrangement is arranged on a first shaft portion of a divided shaft and the fourth spur gear is arranged on a second shaft portion of the divided shaft and fixed with respect to rotation relative to it in each instance. Dividing the shaft into two shaft portions makes it possible to couple the energy storage and damping element to the sun gear of the gear unit of the torsional vibration damper arrangement.

### BRIEF DESCRIPTION OF THE DRAWINGS

The invention will be further described in the following based on a number of embodiment examples shown in the accompanying drawings. The drawings show:

FIG. 1 is a schematic fragmentary longitudinal section through a torsional vibration damper arrangement according to a first embodiment of the invention;

FIG. 2 is a schematic fragmentary longitudinal section through a torsional vibration damper arrangement according to a second embodiment;

FIG. 3 is a schematic fragmentary longitudinal section through a torsional vibration damper arrangement according to a third embodiment;

FIG. 4 is a schematic fragmentary longitudinal section through a torsional vibration damper arrangement according to a fourth embodiment;

FIG. 5 is a schematic fragmentary longitudinal section through a torsional vibration damper arrangement according to a fifth embodiment;

FIG. 6 is a schematic fragmentary longitudinal section through a torsional vibration damper arrangement according to a sixth embodiment;

FIG. 7 is a schematic fragmentary longitudinal section through a torsional vibration damper arrangement according to a seventh embodiment;

FIG. 8 is a schematic fragmentary longitudinal section through a torsional vibration damper arrangement according to an eighth embodiment;

FIG. 9 is a schematic fragmentary longitudinal section through a torsional vibration damper arrangement according to a ninth embodiment;

FIG. 10 is a schematic diagram of a motor vehicle powertrain in which a first constructional variant of a torsional vibration damper arrangement according to a second constructional form is shown between an internal combustion engine and a vehicle transmission;

FIG. 11 is a view as in FIG. 10, but with a second constructional variant of a torsional vibration damper arrangement according to a second constructional form;

FIG. 12 is a view as in FIG. 10, but with a third constructional variant of a torsional vibration damper arrangement according to a second constructional form; and

FIG. 13 is a view as in FIG. 10, but with a fourth constructional variant of a torsional vibration damper arrangement according to a second constructional form.

### DETAILED DESCRIPTION OF THE PRESENTLY PREFERRED EMBODIMENTS

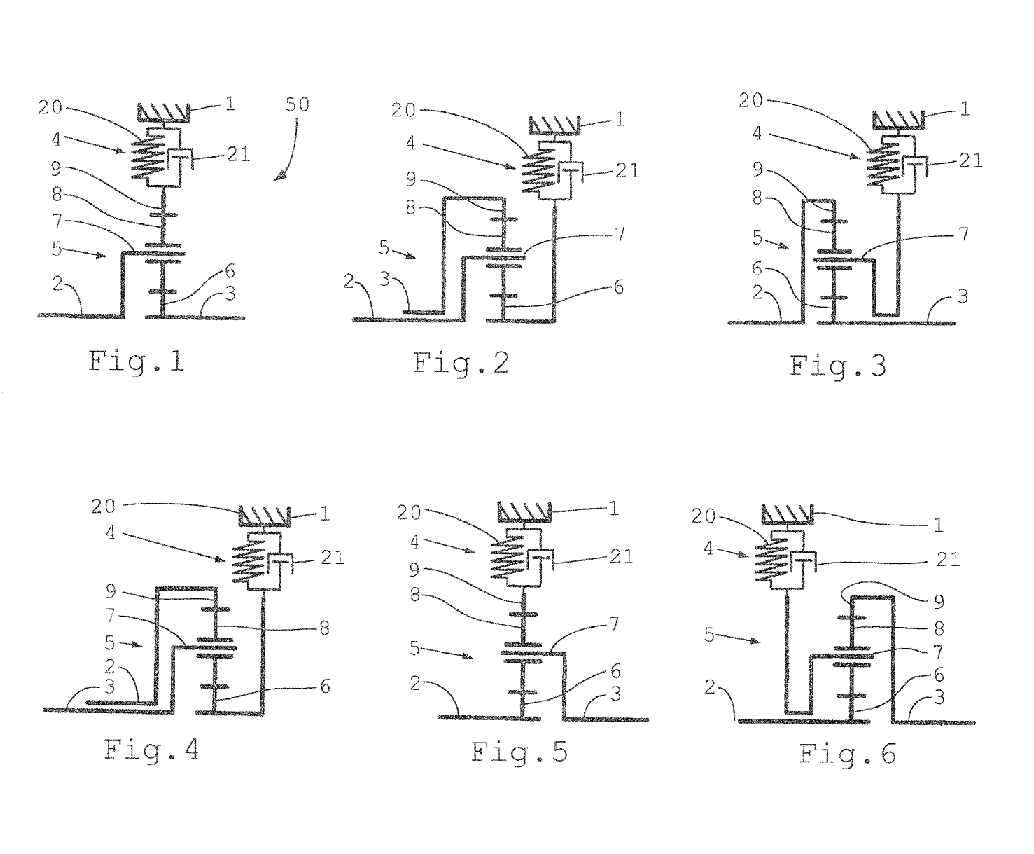

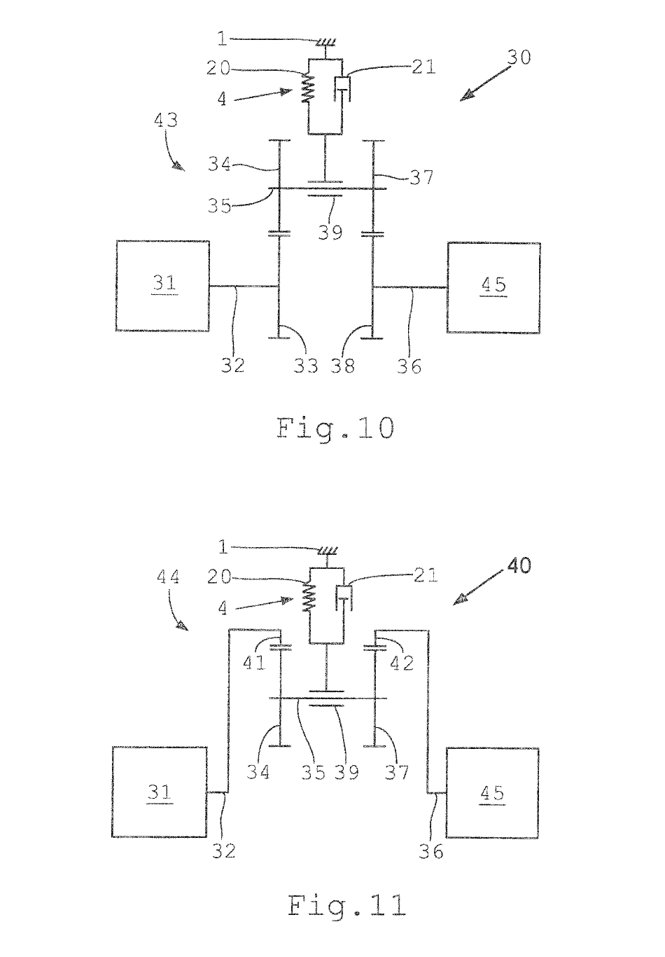

FIGS. 1 to 6 show different possibilities for coupling an energy storage and damping element 4 to a schematically depicted housing 1 in which the energy storage and damping element 4 and a planetary gear unit 5 are arranged. It is preferably a torsional vibration damper arrangement 50 in a powertrain of a motor vehicle with a drive-side transmission element 2 in the form of a shaft and an output-side transmission element 3 likewise in the form of a shaft. This torsional vibration damper arrangement 50 can be arranged in a known manner on the input side with an internal combustion engine 31, shown in FIGS. 10 to 13, and on the output side with a vehicle transmission 45 in the region of a friction clutch and/or a torque converter or inside the vehicle transmission, particularly of an epicyclic automatic transmission 19, shown in FIG. 9.

The energy storage and damping element 4 comprises at least one helical compression spring 20 and a damping member 21 connected parallel thereto can be constructed as a friction damper or as a hydraulic damper.

The energy storage and damping elements 4 are shown folded into the drawing plane along 90° in FIGS. 1 to 13 for a clearer illustration.

The planetary gear unit 5 comprises a sun gear 49 connected to the output-side transmission element 3 and fixed with respect to rotation relative to it in the embodiment according to FIG. 1 and an arm 7 connected to the drive-side transmission element 2 and fixed with respect to rotation relative to it in the embodiment according to FIG. 1 and which guides at least one planet gear 8 that meshes with the sun gear 6 on one side and with a ring gear 9 on the other side, this ring gear 9 coaxially surrounding the sun gear 6.

According to FIG. 1, the ring gear 9 is coupled via the energy storage and damping element 4 directly to the housing 1 such that it cannot be disengaged during operation. The energy storage and damping element 4 ensures the damping of torsional vibrations in the planetary gear unit 5 between the drive-side transmission element 2 and the output-side transmission element 3. The energy storage and damping element 4 can be accommodated in the region of the housing 1 radially and axially outside of the planetary gear unit 5, where a substantially larger installation space is available for the energy storage and damping element 4 so that substantially more energy storage volume can be utilized for damping torsional vibrations.

Since the planetary gear unit 5 comprises three members, namely, sun gear 6, arm 7 with at least one plant gear 8, and ring gear 9, six different variants can be realized for linking to the housing 1.

Referring to FIG. 2, which shows the second linking variant for linking to the housing 1, the drive-side transmission element 2 is coupled to the arm 7 to be fixed with respect to rotation relative to it and the output-side transmission element 3 is coupled to the ring gear 9 to be fixed with respect to rotation relative to it so that, in this embodiment, the sun gear 6 is coupled to the housing 1 via the energy storage and damping element 4.

In the linking variant for linking to the housing 1 shown in FIG. 3, the drive-side transmission element 2 is connected to the ring gear 9 to be fixed with respect to rotation relative to it and the output-side transmission element 3 is connected to the sun gear 6 to be fixed with respect to rotation relative to it such that in this linking variant the arm 7 with the at least one planet gear 8 is coupled to the housing 1 via the energy storage and damping element 4.

Referring to FIG. 4, the drive-side transmission element 2 is coupled to the ring gear 9 to be fixed with respect to rotation relative to it, while the output-side transmission element 3 is connected to the arm 7 to be fixed with respect to rotation relative to it. Accordingly, the sun gear 6 is coupled to the housing 1 via the energy storage and damping element 4.

In the embodiment according to FIG. 5, the drive-side transmission element 2 is coupled to the sun gear 6 so as to be fixed with respect to rotation relative to it, while the output-side transmission element 3 is connected to the arm 7 to be fixed with respect to rotation relative to it. Accordingly, the ring gear 9 is linked to the housing 1 via the energy storage and damping element 4.

The embodiment according to FIG. 6 shows the reverse of the embodiment according to FIG. 3 in that the drive-side transmission element 2 is coupled with the sun gear 6 to be fixed with respect to rotation relative to it and the output-side transmission element 3 is connected to the ring gear 9 to be fixed with respect to rotation relative to it so that, in this case, the arm 7 is again connected to the housing 1 via the energy storage and damping element 4.

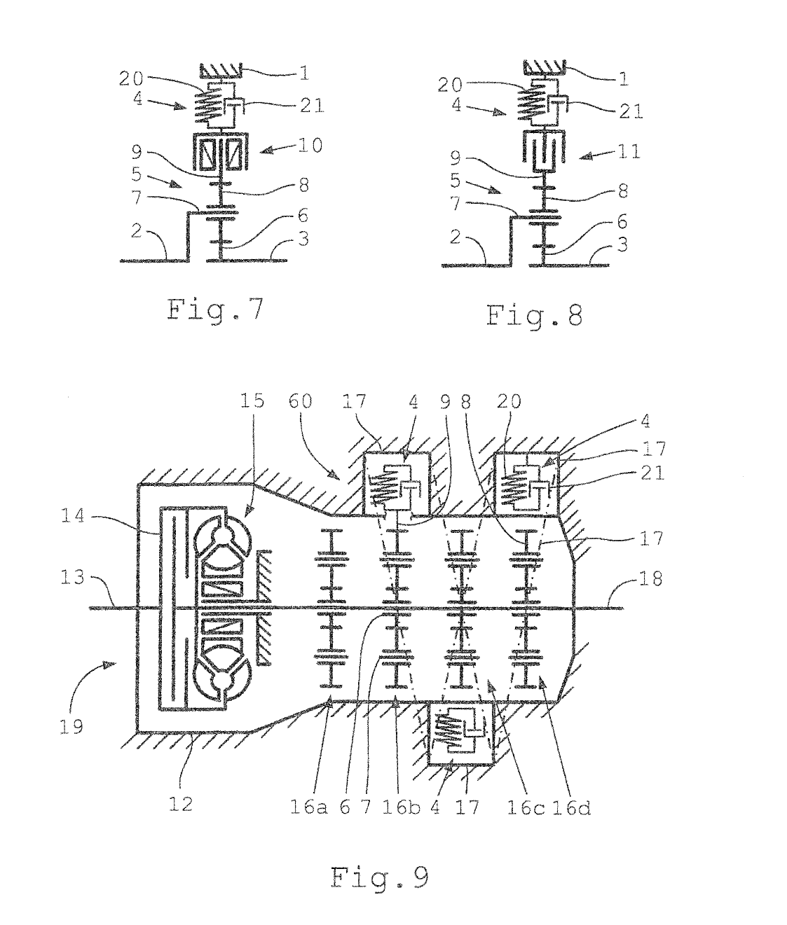

The embodiment according to FIG. 7 corresponds to a great extent to the embodiment according to FIG. 1, but a freewheel 10 is arranged between the ring gear 9 and the energy storage and damping element 4. In its simplest embodiment, the freewheel 10 secures the ring gear 9 in one rotational direction and releases it in the opposite rotational direction. As is well known, freewheels can also be switchable in that they are adapted to block selectively in one rotational direction or in the other rotational direction or in both rotational directions. This freewheel 10 can be arranged in an analogous manner in all of the embodiment forms according to FIGS. 1 to 6.

FIG. 8 depicts an embodiment that shows a brake 11 between the ring gear 9 and the energy storage and damping element 4. Brake 11 can be selectively actuated. Using the brake, it is possible to block or release the ring gear 9 in both rotational directions. This embodiment form with the brake 11 is also suitable for all of the embodiments according to FIGS. 1 to 6.

FIG. 9 shows a very advantageous placement of a torsional vibration damper arrangement 60 having the characteristic features of the invention in a schematically shown epicyclic automatic transmission 19. A drive-side transmission element 13 in the form of a shaft is connected to the input element of a torque converter 15 and of a lockup clutch 14 to be fixed with respect to relative rotation is guided into a substantially cylindrically formed transmission housing 12. The lockup clutch 14 and the torque converter 15 can be selectively actuated in a known manner to produce a rotational connection to four planetary gear sets 16a, 16b, 16c, 16d, which are interconnected with one another. A plurality of stepped forward gears and a reverse gear can be switched by means of these planetary gear sets 16a, 16b, 16c, 16d. The output of this epicyclic automatic transmission 19 is formed by an output-side transmission element 18 in the form of an output shaft which guides a drive torque to drive wheels of the vehicle which are not shown.

The transmission housing 12 is provided with a large-volume circumferential groove 17 that extends in a spiral-shaped manner in axial direction of the transmission housing 12 along more than one circumference length and in which the energy storage and damping element 4 is arranged to extend in circumferential direction. The energy storage and damping element 4 is shown folded into the drawing plane along 90°. Actually, the helical compression spring 20 and the damping member 21 are inserted in circumferential direction into the spiraling circumferential groove 17 and are supported by one end at the ring gear 9 of the planetary gear set 16b and by the other end at a stop, not shown, in the spiral-shaped circumferential groove 17. The energy storage volume, which is made available for damping torsional vibrations, can be influenced by the cross section and the length of the spiral-shaped circumferential groove 17. The larger the cross section of the spiral-shaped circumferential groove 17, the larger the diameter of the helical compression spring 20 can be; and the more turns the spiral-shaped circumferential groove 17 has, the longer the helical compression spring 20 can be, so that a high energy storage density can be realized. The spiraling course of the circumferential groove 17 at the transmission housing 12 is indicated by dash-dot lines.

The three energy storage and damping elements 4 shown in FIG. 9 comprise an individual helical compression spring 20, which takes up the entire length of the spiral-shaped circumferential groove 17 or a plurality of helical compression springs 20 arranged axially one behind the other in circumferential direction and which are supported at the ring gear 9 on one side and in the spiral-shaped circumferential groove 17 on the other side.

Although in FIG. 9 only the second planetary gear set 16b is coupled by its ring gear 9 to the transmission housing 12 via the energy storage and damping element 4, it is also possible to couple two or more of the planetary gear sets 16a, 16b, 16c, 16d to the transmission housing 12 in a manner analogous to the present embodiment example and to interconnect them in parallel and/or in series depending on which of the planetary gear unit members 9 of the planetary gear sets 16 is to be coupled to the transmission housing 12 depending on the gear selection through braking such that at least one energy storage and damping element 4 is always active in every selected gear.

Since the energy storage and damping element 4 can be accommodated in the housing 1 or in the transmission housing 12, where there is a substantially larger potential installation space compared with the known torsional vibration dampers, considerably more energy storage volume can be made available for torsional vibration damping, and the friction effects due to radial accelerations are not great. Further, this mode of construction makes it possible spur gear 37, both of which are arranged on the shaft 35 so as to be fixed with respect to rotation relative to it, also mesh with the ring gear 47.

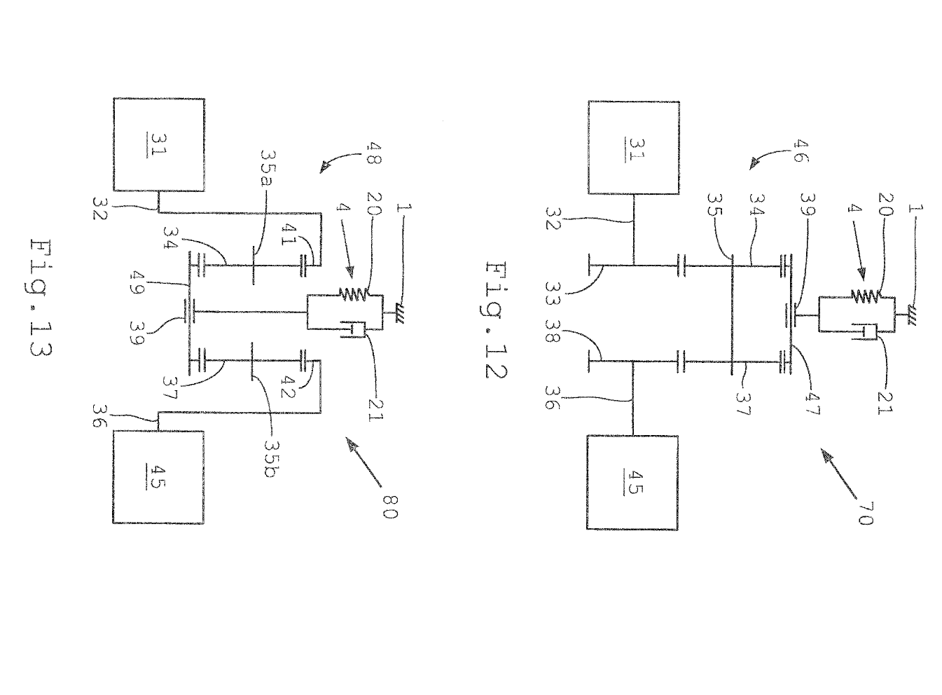

In the two variants of the torsional vibration damper arrangement 40, 80 shown in FIGS. 11 and 13, the input-side transmission element of gear unit 44 and the output-side transmission element of gear unit 48 are formed, respectively, as ring gears 41, 42 connected to the drive shaft 32 of an internal combustion engine 31 and with the input shaft 36 of a vehicle transmission 45, respectively, so as to be fixed with respect to rotation relative thereto. The respective input-side transmission element in the form of the first ring gear 41 meshes with a second spur gear 34 which is arranged on a shaft 35 to be fixed with respect to rotation relative to it. Also fastened to this shaft 35 is a third spur gear 37 in toothed engagement with the output-side transmission element in the form of a second ring gear 42.

In the variant in FIG. 11, the shaft 35 of gear unit 44 is supported by a support 39 to which the energy storage and damping element 4 is fastened. This energy storage and damping element 4 is constructed and arranged in a manner which has already been described in connection with FIGS. 10 and 12.

In the variant according to FIG. 13, a sun gear 49 which is supported at the support 39 of the energy storage and damping element 4 is arranged radially inside in the gear unit 48 of the torsional vibration damper arrangement 80. The energy storage and damping element 4 is constructed in a manner which has already been described and is fastened to the housing 1 on the radially outer side. The second spur gear 34 and the third spur gear 37 are arranged on a divided shaft 35a, 35b to be fixed with respect to rotation relative to it accordingly mesh not only with the teeth of the input-side and output-side ring gears 41, 42, respectively, but also with the teeth of the sun gear 49 arranged radially inside. The shaft 35a, 35b is formed in two parts so as to allow the shaft 35a, 35b and the toothed wheels 34, 37 fastened thereto to be supported in a vibration-damping manner at the housing 1 via the energy storage and damping element 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-23. (canceled)

24. A torsional vibration damper arrangement comprising:
a transmission housing;
a drive-side transmission element;
an output-side transmission element;
a planetary gear unit arranged between the drive-side transmission element and the output-side transmission element, the planetary gear unit comprising:
a sun gear supporting at least one planet gear;
a ring gear; and
at least one energy storage and damping element acting at the planetary gear unit,
wherein a planetary gear unit member consisting of one of the sun gear, or the ring gear is coupled to the transmission housing via the at least one energy storage and damping element.

25. The torsional vibration damper arrangement according to claim 24,
wherein the planetary gear unit member is directly coupled to the at least one energy storage and damping element such that it cannot be disengaged during operation.

26. The torsional vibration damper arrangement according to claim 24,
wherein the planetary gear unit member is indirectly coupled to the at least one energy storage and damping element such that it can be disengaged during operation.

27. The torsional vibration damper arrangement according to claim 26, further comprising:
a brake arranged between the planetary gear unit member and the at least one energy storage and damping element and configured to be selectively actuated.

28. The torsional vibration damper arrangement according to claim 26, further comprising:
a freewheel arranged between the planetary gear unit member and the at least one energy storage and the damping element.

29. The torsional vibration damper arrangement according to one of claim 24,
wherein the planetary gear unit is arranged inside a vehicle transmission.

30. The torsional vibration damper arrangement according to claim 29,
wherein the vehicle transmission is constructed as one of:
an epicyclic automatic transmission,
an automatic spur gear transmission or
an automatic compound transmission with a transfer case, a main gear unit and/or a range gear unit,
wherein individual sub-gear units are formed as one of spur gear units and planetary gear units.

31. The torsional vibration damper arrangement according to claim 30,
wherein the epicyclic automatic transmission has at least one planetary gear set with housing link, and
wherein the planetary gear unit members of at least one planetary gear set are coupled to the transmission housing via at least one energy storage and damping element.

32. The torsional vibration damper arrangement according to claim 30,
wherein the epicyclic automatic transmission has at least two planetary gear sets with housing link, and
wherein one of the planetary gear unit members of each of the at least two planetary gear sets with housing link is coupled to the transmission housing.

33. The torsional vibration damper arrangement according to claim 32,
wherein the planetary gear unit members of the at least two planetary gear sets with housing link are coupled to the transmission housing in one of a parallel and serial connection.

34. The torsional vibration damper arrangement according to claim 24,
wherein the at least one energy storage and damping element has at least one damping member and at least one helical compression spring arranged in a circumferential groove in the transmission housing.

35. The torsional vibration damper arrangement according to claim 34,
wherein the circumferential groove extends in a spiral-shaped manner in axial direction of the transmission housing over more than one circumference length.

36. The torsional vibration damper arrangement according to claim 34,
wherein the at least one helical compression spring is inserted into the circumferential groove in circumferential direction and is supported at one end at one of the sun gear, or the ring gear and at an other end at a stop in the circumferential groove.

37. The torsional vibration damper arrangement according to claim 34,
wherein the at least one damping member is inserted into the circumferential groove in circumferential direction and is supported at one end at one of the sun gear, or the ring gear and at an other end thereof at a stop in the circumferential groove.

38. The torsional vibration damper arrangement according to claim 24,
wherein the planetary gear unit is one of:
a minus gear unit having a stationary gear ratio of less than zero, and
a plus gear unit with a stationary gear ratio of greater than zero.

39. The torsional vibration damper arrangement according to claim 24,
wherein the at least one planet gear of the planetary gear unit is a step planet gear.

40. The torsional vibration damper arrangement according to claim 24,
wherein the at least one planet gear of the planetary gear unit is one of a spur gear and a bevel gear.

41. A torsional vibration damper arrangement for a powertrain of a vehicle mounted in a housing and drivingly arranged between an internal combustion engine and a vehicle transmission, comprising:
a gear unit comprising:
a drive-side transmission element formed as a first toothed wheel and configured to be connected to a drive shaft of the internal combustion engine; and
an output-side transmission element formed as a fourth toothed wheel is fixedly arranged on a second shaft and configured to be connected to an input shaft of the vehicle transmission,
a second toothed wheel fixedly arranged on a shaft with respect to rotation that meshes with the first toothed wheel;
a third toothed wheel in toothed engagement with the fourth toothed wheel;
at least one support which supports the second shaft;
one of a ring gear and a sun gear of the gear unit; and
an energy storage and damping element comprising:
at least one damping member; and
at least one helical compression spring arranged parallel to the at least one damping member in operative direction and fastened to the at least one support,
wherein the energy storage and damping element is configured to be connected to the housing on a radially outer side.

42. The torsional vibration damper arrangement according to claim 41,
wherein the drive-side transmission element and the output-side transmission element of the gear unit are each formed as a spur gear.

43. The torsional vibration damper arrangement according to claim 41,
wherein the third spur gear and the fourth spur gear mesh with an individual ring gear of the gear unit.

44. The torsional vibration damper arrangement according to claim 41,
wherein the drive-side transmission element of the gear unit is a first ring gear and the output-side transmission element of the gear unit is a second ring gear.

45. The torsional vibration damper arrangement according to claim 41,
wherein the third spur gear and the fourth spur gear are configured to mesh with an individual sun gear of the gear unit.

46. The torsional vibration damper arrangement according to claim 45,
wherein the third spur gear is arranged on a first shaft portion of a divided shaft and the fourth spur gear is arranged on a second shaft portion of the divided shaft to be fixed with respect to rotation relative to it in each instance.
